(19) United States
(12) Patent Application Publication
(10) Pub. No.: US 2026/0193112 A1
(43) Pub. Date: Jul. 9, 2026

(54) CHEMICAL GENERATOR ELECTROLYTIC CELL WITH EDGE PATH BARRIERS

(71) Applicant: FLUIDRA GROUP AUSTRALIA PTY LTD, Smithfield NSW (AU)

(72) Inventor: Dime Risteski, Melbourne VIC (AU)

(73) Assignee: FLUIDRA GROUP AUSTRALIA PTY LTD, Smithfield NSW (AU)

(21) Appl. No.: 19/441,121

(22) Filed: Jan. 6, 2026

Related U.S. Application Data
(60) Provisional application No. 63/743,120, filed on Jan. 8, 2025.

(51) Int. Cl. C02F 1/461; C02F 1/467; C02F 103/42

(52) U.S. Cl. CPC C02F 1/46109; C02F 1/4674; C02F 2001/46142; C02F 2001/46152; C02F 2103/42

(57) ABSTRACT

A chemical generator for pool or spa applications includes an electrolytic cell comprised of a parallel set of conductive sheets submerged in an electrolyte. A set of path barriers is positioned to obstruct current paths along the edges between sheets, thereby increasing cell efficiency and protecting edge regions from high current densities. The invention covers both planar configurations and cylindrical implementations, including edge-coupled barriers that extend along the sheet perimeters or between a core and sleeve in cylindrical form. Methods for installing and operating the cell, including chlorine production within a chlorinator system, are also disclosed.

### REFERENCE TO RELATED APPLICATION

This application claims the benefit of and priority to U.S. Provisional Application Ser. No. 63/743,120, filed on Jan. 8, 2025, and titled “Chemical Generator Electrolytic Cell with Edge Path Barriers”, the content of which is hereby incorporated by reference in its entirety.

### FIELD OF THE INVENTION

The invention relates to chemical generators with electrolytic cells that may be used for production of chemicals such as chlorine for bodies of water such as swimming pools and spas, and more particularly, but not necessarily exclusively, an electrolytic cell having improved efficiency properties.

### BACKGROUND OF THE INVENTION

In many settings (industrial, commercial, etc.) desired chemicals are produced via an electrochemical reaction, in an electrolytic cell. One example is the production of chlorine in chlorinators for a swimming pool or spa, which may have an electrolytic cell as a component. Traditional arrangements of electrolytic cells may have limited efficiency, increased operating costs, and/or components with a reduced operating life.

### SUMMARY OF THE INVENTION

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the specification of this patent, any or all drawings, and each claim.

According to certain embodiments, a chemical generator for a pool or spa includes an electrolytic cell including at least two electrically conductive components including a first electrically conductive component and a second electrically conductive component, the first and second electrically conductive components being bounded by an edge in at least one direction, and a set of path barriers positioned between edges on the at least two electrically conductive components to obstruct at least a portion of the electrical path.

According to various embodiments, a chemical generator for a pool or spa includes a vessel sized to house the electrolytic cell and to contain an electrolyte solution in an arrangement in which at least the two electrically conductive components are submerged in the electrolyte solution.

According to some embodiments, a chemical generator for a pool or spa includes an electrolytic cell including a set of sheets of conductive material forming at least one face arranged in parallel and a set of path barriers positioned to obstruct at least a portion of a path between edges on different sheets in a set.

According to certain embodiments, an electrolytic cell for a chemical generator for a pool or spa includes a voltage source coupled with the set of sheets and configured to cause a current flow through the faces of the sheets.

According to various embodiments, an electrolytic cell for a chemical generator for a pool or spa includes a given path barrier coupled at the edge of a given sheet and arranged to extend in the width direction or in the length direction as an extension or continuation of the given sheet.

According to some embodiments, a chemical generator for a pool or spa includes an electrolytic cell including conductive components having a cylindrical form, the conductive components include a core having a diameter, at least one sleeve having a diameter larger than the core diameter, and a set of path barriers positioned between the core and the at least one sleeve having a diameter of a size in between the core and sleeve diameter and arranged to extend at least partially between the core and the sleeve.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 illustrates a pool system according to certain embodiments.

FIG. 2A is a perspective view of a chemical generator with an electrolytic cell according to various embodiments.

FIG. 2B is a side view of a chemical generator with an electrolytic cell according to some embodiments.

FIG. 3A is a side view of a chemical generator with an electrolytic cell according to certain embodiments

FIG. 3B is a side view of a chemical generator with an electrolytic cell according to additional embodiments.

FIG. 4A is a perspective view of a chemical generator with an electrolytic cell according to further embodiments.

FIG. 4B is a side view of a chemical generator with an electrolytic cell according to various embodiments.

### DESCRIPTION OF THE INVENTION

Described herein are systems and methods for providing electrolytic cells for chemical production, such as for a swimming pool or spa. In certain embodiments, the systems and methods described herein may allow for improved efficiency properties.

In various embodiments, the systems and methods described herein include a chemical generator such as a chlorinator. The chemical generator may include path barriers that block undesirable current paths along edges of conductive components in an electrolytic cell of the chemical generator. This may increase efficiency of the cell and protect the edges of the cell from increased current densities. Various other benefits and advantages may be realized with the systems, devices, and methods provided herein, and the aforementioned advantages should not be considered limiting.

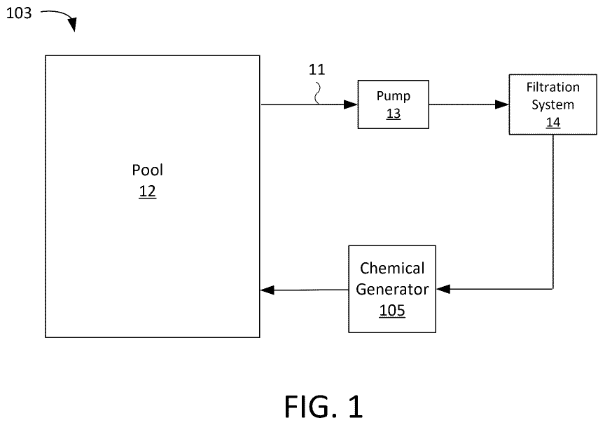

FIG. 1 illustrates a pool system 103 according to certain embodiments. The pool system 103 may include a pool 12 and a circulation loop 11 further having at least a chemical generator 105 according to some embodiments. In further embodiments, the circulation loop 11 may include a pump 13 and a filtration system 14 in addition to the chemical generator 105. In certain embodiments, the chemical generator 105 may be a chlorinator which provides chlorine to the water passing through the circulation loop 11 in the pool system 10.

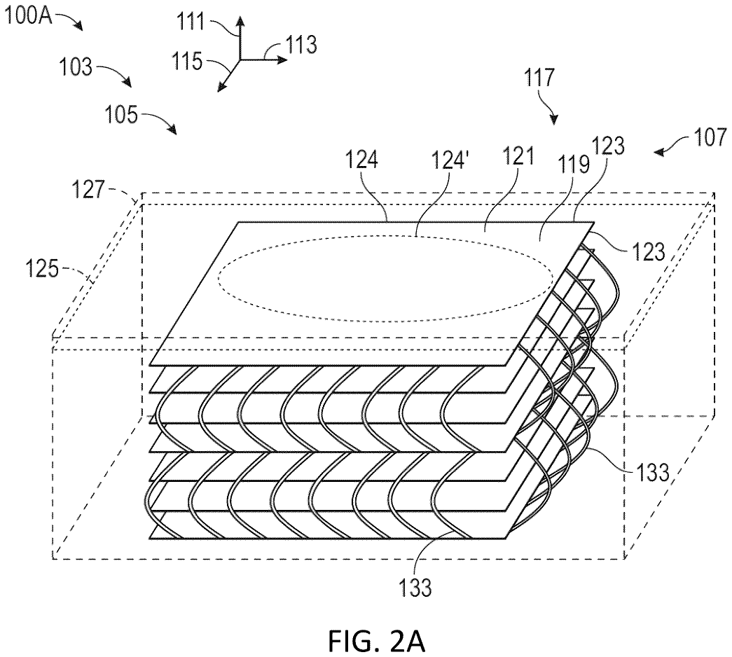

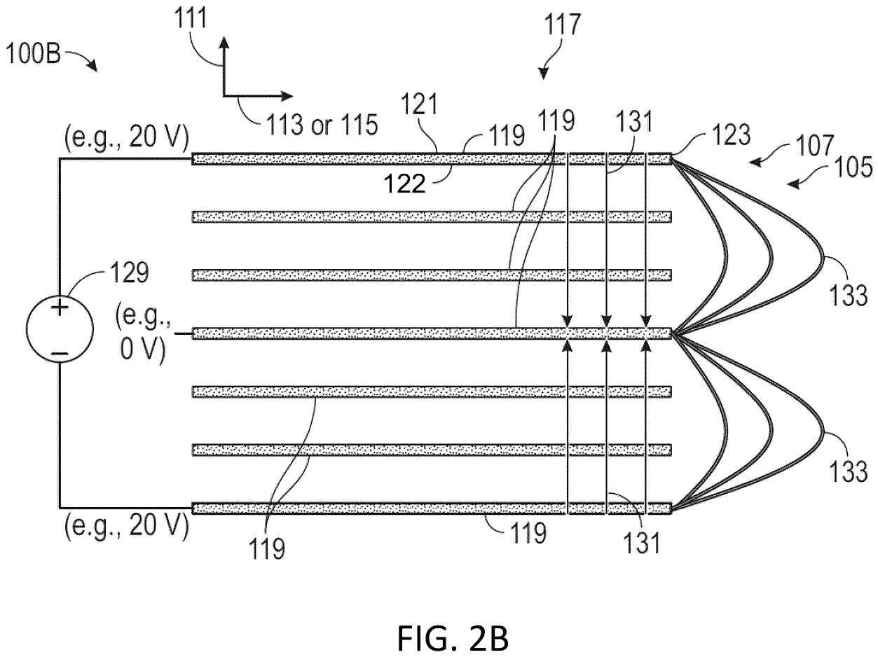

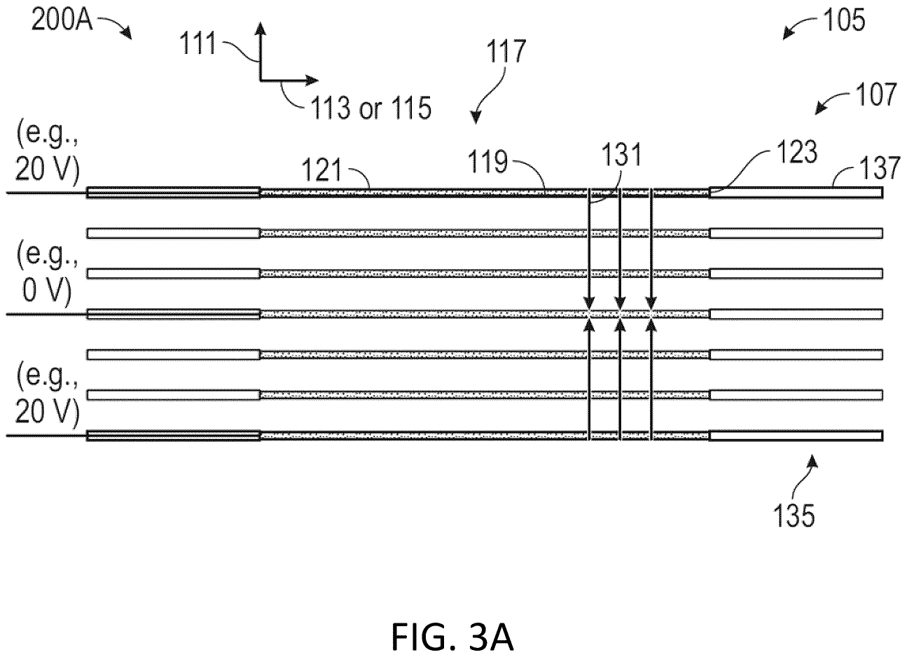

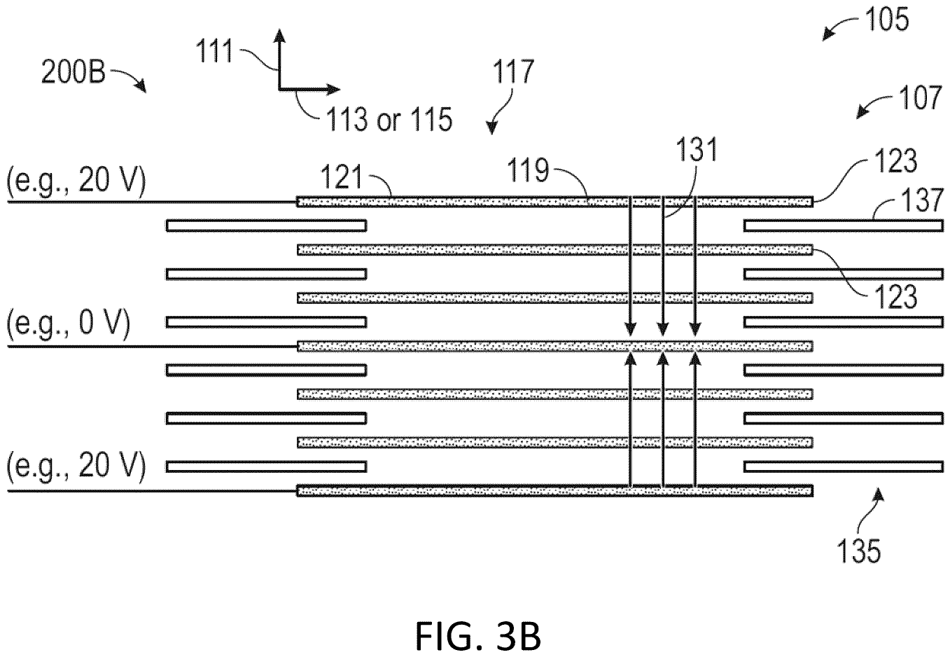

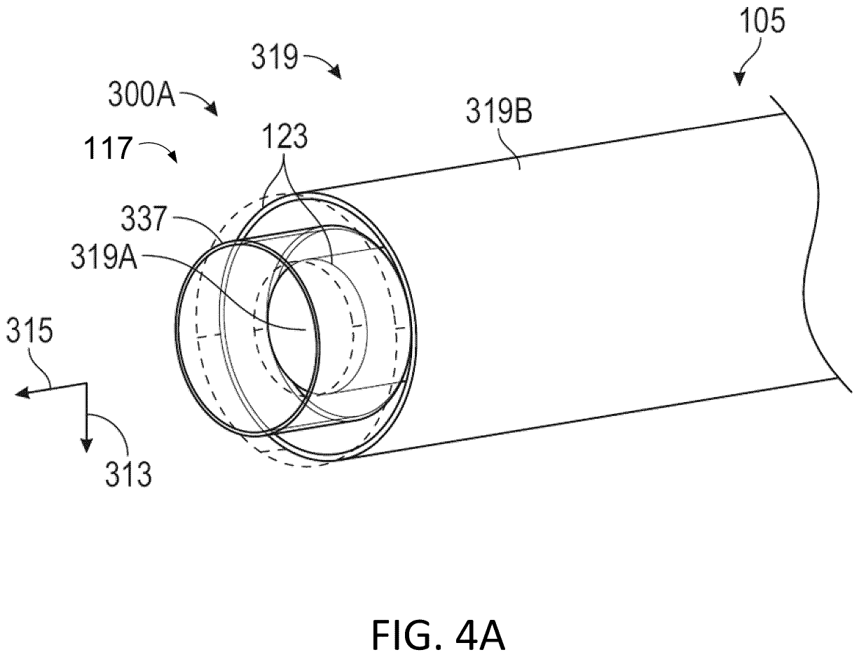

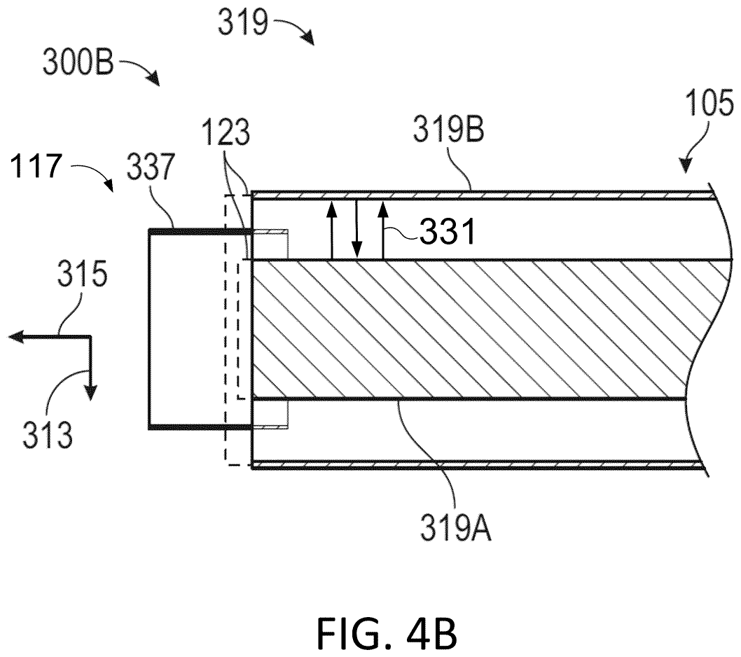

FIGS. 2A-4B illustrate examples of a chemical generator 105 according to various embodiments. FIGS. 2A-4B show a chemical generator 105 in isolation from other elements of the pool system 103 for illustrative purposes. According to some embodiments, the electrolytic cell 107 may include at least two electrically conductive components 117, each with an edge 123. The conductive components 117 may be sheets 119 (see, e.g., FIGS. 2A-3B), a core 319A (see, e.g., FIGS. 4A-4B), a sleeve 319B (see, e.g., FIGS. 4A-4B), any combination thereof, or other conductive components 117 as desired. FIGS. 2A-4B further illustrate a set of path barriers 137, 337 positioned between edges 123 on the at least two electrically conductive components 117 to obstruct at least a portion of an electrical path 131, 331.

FIGS. 2A and 2B illustrate an example of a chemical generator 105 where the electrically conductive components 117 are sheets 119. FIG. 2A illustrates a 3-dimensional perspective view 100A of a chemical generator 105 according to embodiments. FIG. 2B shows a 2-dimensional side view 100B of a chemical generator 105 according to other embodiments. In certain embodiments, the chemical generator 105 may include an electrolytic cell 107. The electrolytic cell 107 may be defined in terms of directions such as a depth direction 111, a width direction 113, and a length direction 115, among others. Although seven sheets 119 are depicted in FIGS. 2A and 2B, any other suitable number may be utilized in other embodiments. In certain embodiments, a sheet 119 may be formed at least in part by a suitable electrically conductive material. In some non-limiting examples, a sheet 119 may include at least one face 121, 122 that extends in the width direction 113 and the length direction 115. As a non-limiting example, and as most easily seen in the view 100B in FIG. 2B, each sheet 119 may have opposing faces—one face 121 on of a top side of the sheet 119 and another face 122 on a bottom side of the sheet 119.

In certain embodiments, each face 121, 122 may be bounded by at least one edge 123. The edge 123 may define a lateral boundary or periphery of the face 121, 122 of the sheet 119 and extends in at least one direction 111, 113, 115. Although the edges 123 in FIGS. 2A and 2B are shown in solid lines forming a substantially rectangular shape 124 for an outer periphery of the face 121, FIG. 2A also includes dotted lines showing an elliptical shape 124′ to illustrate that the edges 123 may alternatively have any profile or shape as desired. Moreover, the sheet 119 is not limited to a planar form but may include undulating, ridged, curved, or other three-dimensional forms in use.

In some embodiments, and as illustrated in FIGS. 2A and 2B, as a non-limiting example, the at least two electrically conductive components 117 may be arranged to be submerged in an electrolyte 125 (e.g., a brine). In certain embodiments, and as illustrated in FIG. 2A, as a non-limiting example, the at least two electrically conductive components 117 may be included in a vessel 127 sized to house the electrolytic cell 107 and to contain the electrolyte 125 in an arrangement in which at least a portion of the at least two electrically conductive components 117 are at least partially submerged in the electrolyte 125.

In some embodiments, the chemical composition of the electrolyte 125 and the conductive material in the sheets 119 may be selected based on the chemical to be generated by the chemical generator 105. As a non-limiting example, the chemical generator 105 may be configured to produce chlorine as a portion of a chlorinator, and non-limiting examples of corresponding suitable chemical compositions of the electrolyte 125 may include sodium chloride, magnesium chloride, and/or potassium chloride, among other possibilities. In some embodiments, the at least two electrically conductive components 117 may correspond to anode and cathode structures. In such embodiments, the at least two electrically conductive components 117 may be an anode and cathode structures utilizing various materials, such as but not limited to inert materials, metallic conductor materials, and/or non-metallic conductor materials, among others. Non-limiting examples for the conductive material in the at least one component 117 may include layers such as titanium, stainless steel, a conductive plastic, a sulfonic acid-based layer (PFSA), and/or a carboxylic acid-based layer (PFCA), although other options are also possible for producing chlorine and/or other chemicals. In some examples, at least one of the electrically conductive components 117 may be coated with copper chloride, ruthenium, or other suitable catalyst. In an illustrative example, titanium plates for the at least one conductive component 117 may be implemented with ruthenium coating for the catalyst and utilized with sodium chloride and/or magnesium chloride for the electrolyte 125, although other combinations of chemical compositions may be utilized.

In certain embodiments, and as illustrated in FIG. 2B, a voltage source 129 may be coupled with the at least two electrically conductive components 117 for applying a voltage to drive the electrochemical reaction to produce the target chemical. In a non-limiting example, a voltage of approximately 20 volts may be applied, although other suitable voltages may be utilized as desired. In some embodiments, the voltage source 129 may be configured to cause a current flow through the faces 121, 122 of the sheets 119 along the electrical path 131 between the conductive components 117. Similarly, current paths may occur along edges 123, such as depicted by arrows 133.

In certain embodiments, and as described in detail below, the electrolytic cell may include a set 135 of path barriers 137, 337 to reduce amounts of current that can flow along edges 123 (e.g., in paths depicted by arrows 133). A set 135 of path barriers 137, 337 may reduce the amount of current and increase efficiency of the cell and/or protect the edges of the cell from increased current densities, among other benefits. FIGS. 3A-B and 4A-B illustrate non-limiting examples of a set of path barriers and are described in greater detail below.

FIGS. 3A and 3B show side views 200A, 200B that are each similar to the side view 100B of FIG. 2B. The electrolytic cell 107 of the chemical generator 105 may include a set 135 of one or more path barriers 137. In certain embodiments, the path barriers 137 may be formed of a material that is less electrically conductive than the conductive material in the at least one electrically conductive component 117. Non-limiting examples of corresponding suitable chemical compositions of the path barriers 137 include, but are not limited to, one or more layers such as a rubber-based layer, one or more layers of acrylonitrile butadiene styrene (ABS), or other non-conductive material that can withstand contact with the electrolyte, although other options are also possible for producing chlorine and/or other chemicals.

The set 135 of path barriers 137 may be arranged to obstruct at least a portion of a path between edges 123 of conductive material on different electrically conductive components 117. In the non-limiting example illustrated in FIG. 3A, a set 135 of path barriers 137 may be arranged at the edge 123 of a given sheet 119 as an extension or continuation of the given sheet 119. As a non-limiting example, the set 135 of path barriers 137 may be arranged to extend at least partially along a part or all of a periphery of the sheet 119, such as a frame arranged surrounding a periphery of the sheet 119 or along a subset of fewer than all edges 123 of the sheet 119. As another non-limiting example, in FIG. 3B, at least one path barrier 137 may be positioned between edges 123 of two particular sheets 119.

Including and/or arranging the path barriers 137 in the electrolytic cell 107 may minimize and/or substantially reduce current from flowing along the edges 123 (such as preventing current along the current paths 133 illustrated by arrows in FIG. 2A-B). As a non-limiting example, including the path barriers 137 may increase the distance between the conductive components 117 in the electrolytic cell 107, which results in a higher resistance and hence a lower current and reduced current path 133 along the edges 123.

Reducing and/or preventing current along the edges 123 may increase efficiency of the electrolytic cell 107 and/or may protect the edges 123 of the electrolytic cell 107 from increased current densities. As a non-limiting example, reducing or minimizing current along the edges 123 may increase the efficiency of the electrolytic cell 107 in terms of current in vs. mol of product produced. Additionally, or alternatively, reducing or minimizing current along the edges 123 may provide an increase in the production of the desired chemical from the electrochemical reaction.

FIGS. 4A and 4B show a perspective view 300A and a side view 300B, respectively, of a portion of chemical generator 105 in a cylindrical form. In certain embodiments, the at least two conductive components 117 may be a core 319A and at least one sleeve 319B. The conductive components 117 may include a core 319A having a diameter or cross-sectional size and at least one sleeve 319B having a larger diameter or cross-sectional size. In some embodiments, the at least one sleeve 319B may be a plurality of concentric sleeves 319B of differing diameters or cross-sectional sizes. In embodiments with a plurality of concentric sleeves 319B, a path barrier 337 may be positioned between each adjacent sleeve 319B, creating alternating layers of conductive sleeves 319B and path barriers 337.

FIGS. 4A and 4B illustrate a path barrier 337 according to some embodiments where the electric cell 107 is in cylindrical form. The path barrier 337 may be included in a position arranged to obstruct at least a portion of a path 331 between edges 123 of the core 319A and the sleeve 319B. As a non-limiting example, as shown by way of example by solid lines in FIG. 3, the path barrier 337 may include a size in between the core 319A and the at least one sleeve 319B and may be suitably arranged in between to guide or obstruct current flow along the path 331. In certain embodiments, the current may flow from the core 319A to the sleeve 319B. In other embodiments, the current may flow from the sleeve 319B to the core 319A depending on the configuration of the voltage source 129. In some non-limiting embodiments, the path barrier 337 may be arranged to extend at least partially between the core 319A and the sleeve 319B in a lateral or radial direction 313. In further non-limiting embodiments, the path barrier may be arranged to protrude in a longitudinal direction 315 past an edge 123 of the core 319A and/or the at least one sleeve 319B. As other non-limiting examples shown in dashed lines, the path barrier 337 additionally or alternatively may be coupled with or formed as an extension or continuation of an end of either the core 319A, the at least one sleeve 319B, or both and extend in a longitudinal direction 315 to guide or obstruct current flow.

Various other benefits and advantages may be realized with the systems, devices, and methods provided herein, and the aforementioned advantages should not be considered limiting.

Exemplary concepts or combinations of features of the invention may include:
A. A chemical generator for a pool or spa, the chemical generator comprising:
   i. an electrolytic cell comprising:
      i. a set of sheets each including a panel of conductive material
      forming at least one face that extends in a length direction and a width direction and that is bounded by at least one edge extending in a depth direction, wherein the set of sheets is arranged in parallel and configured to be submerged in an electrolyte; and
   ii. a set of path barriers extending in the width direction or in the length direction or in both directions to obstruct at least a portion of a path between edges on different sheets in the set.
B. The chemical generator of any preceding or subsequent statement or combination of statements, further comprising a vessel sized to house the electrolytic cell and to contain the electrolyte in an arrangement in which at least the set of sheets are submerged in the electrolyte.
C. The chemical generator of any preceding or subsequent statement or combination of statements, wherein the chemical generator is configured to produce chlorine as a portion of a chlorinator.
D. The chemical generator of any preceding or subsequent statement or combination of statements, further comprising a voltage source coupled with the set of sheets and configured to cause a current flow through the faces of the sheets.
E. The chemical generator of any preceding or subsequent statement or combination of statements, wherein at least one of the sheets is coated with a catalyst.
F. The chemical generator of any preceding or subsequent statement or combination of statements, wherein the set of path barriers are formed of a material that is less electrically conductive than the conductive material in the set of sheets.
G. The chemical generator of any preceding or subsequent statement or combination of statements, wherein a given path barrier is coupled at the edge of a given sheet and arranged to extend in the width direction or in the length direction or in both directions as an extension or continuation of the given sheet.
H. The chemical generator of any preceding or subsequent statement or combination of statements, wherein a particular path barrier is positioned in the depth direction between edges of two particular sheets.
I. A component for swimming pool or spa and comprising the chemical generator of any preceding or subsequent statements or combination of statements.
J. A swimming pool or spa comprising the chemical generator of any preceding or subsequent statements or combination of statements.
K. A method comprising:
   i. providing an electrolytic cell comprising:
      i. a set of sheets each including a panel of conductive material forming at least one face that is extending in a length direction and a width direction and that is bounded by at least one edge extending in a depth direction, wherein the set of sheets is arranged in parallel and configured to be submerged in an electrolyte; and
   ii. installing a set of path barriers to be extending in the width direction or in the length direction or in both directions to obstruct at least a portion of a path between edges on different sheets in the set.
L. The method of any preceding or subsequent statement or combination of statements, further comprising positioning the electrolytic cell with the installed path barriers into a vessel sized to house the electrolytic cell and to contain the electrolyte in an arrangement in which at least the set of sheets are submerged in the electrolyte.
M. The method of any preceding or subsequent statement or combination of statements, further comprising operating the electrolytic cell with the installed path barriers to generate chlorine as a portion of a chlorinator.
N. The method of any preceding or subsequent statement or combination of statements, further comprising applying a voltage to the set of sheets to cause a current flow through the faces of the sheets.
O. The method of any preceding or subsequent statement or combination of statements, further comprising arranging a given path barrier at the edge of a given sheet to extend in the width direction or in the length direction or in both directions as an extension or continuation of the given sheet.
P. The method of any preceding or subsequent statement or combination of statements, further comprising arranging a particular path barrier to be positioned in the depth direction between edges of two particular sheets.
Q. The method of any preceding or subsequent statement or combination of statements, further comprising incorporating the electrolytic cell with the installed path barriers into a component for swimming pool or spa.
R. The method of any preceding or subsequent statement or combination of statements, further comprising incorporating the electrolytic cell with the installed path barriers into a swimming pool or spa.
S. A chemical generator for a pool or spa, the chemical generator comprising:
   i. an electrolytic cell comprising:
      i. at least two electrically conductive components including a first electrically conductive component and a second electrically conductive component, the first and second electrically conductive components being bounded by an edge in at least one direction, and
      ii. a set of path barriers positioned between edges on the at least two electrically conductive components to obstruct at least a portion of the electrical path.
T. The chemical generator of any preceding or subsequent statement or combination of statements, further comprising a vessel sized to house the electrolytic cell and to contain an electrolyte solution in an arrangement in which at least the two electrically conductive components are submerged in the electrolyte solution.
U. The chemical generator of any preceding or subsequent statement or combination of statements, further comprising a voltage source coupled with the at least two electrically conductive components and configured to cause a current flow through the electrical path formed by the components.
V. The chemical generator of any preceding or subsequent statement or combination of statements, wherein at least one of the electrically conductive components is coated with a catalyst.
W. The chemical generator of any preceding or subsequent statement or combination of statements, wherein the set of path barriers is formed of a material that is less electrically conductive than the material in the at least two electrically conductive components.
X. The chemical generator of any preceding or subsequent statement or combination of statements, wherein the at least two electrically conductive components comprise a set of sheets each including a panel of conductive material forming at least one face that extends in a length direction and a width direction and that is bounded by at least one edge extending in a depth direction, wherein the set of sheets is arranged in parallel.
Y. The chemical generator of any preceding or subsequent statement or combination of statements, further comprising the chemical generator having a cylindrical form, the first conductive component comprising a core having a diameter, the at least second component comprising a sleeve having a diameter larger than the core diameter, and the set of path barriers being positioned between the core and the sleeve having a diameter of a size in between the core and sleeve diameter arranged to extend at least partially between the core and the at least one sleeve in a lateral or radial direction and to protrude in a longitudinal direction beyond an edge of the sleeve and core.
Z. A chemical generator for a pool or spa, the chemical generator comprising:
   i. An electrolytic cell comprising:
      1. conductive components comprising a cylindrical form, the conductive components further comprising:
         a. a core having a diameter; and
         b. at least one sleeve having a diameter larger than the core diameter;
         c. a set of path barriers positioned between the core and at least one sleeve having a diameter of a size in between the core and sleeve diameter; and arranged to extend at least partially between the core and the at least one sleeve in a lateral or radial direction and to protrude in a longitudinal direction beyond an edge of the sleeve and core.
AA. The chemical generator of any preceding or subsequent statement or combination of statements, wherein the set of path barriers is coupled with the edge of the core and extends in a longitudinal direction from the core edge.
BB. The chemical generator of any preceding or subsequent statement or combination of statements, wherein the set of path barriers is coupled with the edge of the sleeve and extends in a longitudinal direction from the sleeve edge.
CC. The chemical generator of any preceding or subsequent statement or combination of statements, wherein the set of path barriers is coupled with both the edge of the core and the edge of the at least one sleeve and extends in a longitudinal direction from the core edge and sleeve edge.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools or spas, persons skilled in the relevant field will recognize that the present invention conceivably could be employed in connection with other water containing vessels and in other manners, particularly but not limited to underwater or overwater installations. Finally, references to “pools” and “swimming pools” herein may also refer to spas or other water containing vessels used for recreation, training, or therapy.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed:

1. A chemical generator for a pool or spa, the chemical generator comprising:
an electrolytic cell comprising:
at least two electrically conductive components comprising a first electrically conductive component and a second electrically conductive component, the first and second electrically conductive components being bounded by an edge in at least one direction; and
a set of path barriers positioned between edges on the at least two electrically conductive components to obstruct at least a portion of an electrical path.

2. The chemical generator of claim 1, further comprising a vessel sized to house the electrolytic cell and to contain an electrolyte solution in an arrangement in which at least the two electrically conductive components are submerged in the electrolyte solution.

3. The chemical generator of claim 1, wherein the chemical generator is configured to produce chlorine as a portion of a chlorinator.

4. The chemical generator of claim 1, further comprising a voltage source coupled with the at least two electrically conductive components and configured to cause a current flow through the electrical path formed by the components.

5. The chemical generator of claim 1, wherein at least one of the electrically conductive components is coated with a catalyst.

6. The chemical generator of claim 1, wherein the set of path barriers is formed of a material that is less electrically conductive than the material in the at least two electrically conductive components.

7. The chemical generator of claim 1, wherein the at least two electrically conductive components comprise a set of sheets including a panel of conductive material forming at least one face that extends in a length direction and a width direction and that is bounded by at least one edge extending in a depth direction, wherein the set of sheets is arranged in parallel.

8. The chemical generator of claim 1, wherein the chemical generator has a cylindrical form, the first conductive component comprises a core having a diameter, at least a second conductive component comprises at least one sleeve having a diameter larger than the core diameter, and the path barrier is positioned between the core and the at least one sleeve having a diameter of a size in between the core and sleeve diameter arranged to extend at least partially between the core and the at least one sleeve in a lateral or radial direction and to protrude in a longitudinal direction beyond an edge of the at least one sleeve and core.

9. A chemical generator for a pool or spa, the chemical generator comprising:
an electrolytic cell comprising:
a set of sheets comprising a panel of conductive material forming at least one face that extends in a length direction and a width direction and that is bounded by at least one edge extending in a depth direction, wherein the set of sheets is arranged in parallel and configured to be submerged in an electrolyte; and
a set of path barriers extending in the width direction or in the length direction or in both directions to obstruct at least a portion of a path between edges on different sheets in the set.

10. The chemical generator of claim 9, further comprising a vessel sized to house the electrolytic cell and to contain the electrolyte in an arrangement in which at least the set of sheets are submerged in the electrolyte.

11. The chemical generator of claim 9, wherein the chemical generator is configured to produce chlorine as a portion of a chlorinator.

12. The chemical generator of claim 9, further comprising a voltage source coupled with the set of sheets and configured to cause a current flow through the faces of the sheets.

13. The chemical generator of claim 9, wherein at least one of the sheets is coated with a catalyst.

14. The chemical generator of claim 9, wherein the set of path barriers are formed of a material that is less electrically conductive than the conductive material in the set of sheets.

15. The chemical generator of claim 9, wherein a given path barrier is coupled at the edge of a given sheet and arranged to extend in the width direction and/or in the length direction as an extension or continuation of the given sheet.

16. The chemical generator of claim 9, wherein a particular path barrier is positioned in the depth direction between edges of two particular sheets.

17. A chemical generator for a pool or spa, the chemical generator comprising:
an electrolytic cell comprising:
conductive components comprising a cylindrical form, the conductive components further comprising:
a core having a diameter;
at least one sleeve having a diameter larger than the core diameter; and
a set of path barriers positioned between the core and at least one sleeve having a diameter of a size in between the core and sleeve diameter and arranged to extend at least partially between the core and the at least one sleeve in a lateral or radial direction and to protrude in a longitudinal
direction beyond an edge of the sleeve and core.

18. The chemical generator of claim 17, wherein the set of path barriers is coupled with the edge of the core and extends in a longitudinal direction from a core edge.

19. The chemical generator of claim 17, wherein the set of path barriers is coupled with the edge of the sleeve and extends in a longitudinal direction from the sleeve edge.

20. The chemical generator of claim 17, wherein the set of path barriers is coupled with both the edge of the core and the edge of the sleeve and extends in a longitudinal direction from a core edge and sleeve edge.
